(19) United States
(12) Patent Application Publication
(10) Pub. No.: US 2022/0198457 A1
(43) Pub. Date: Jun. 23, 2022

(54) DEBT REPAYMENT SYSTEM AND DEBT MANAGEMENT METHOD

(71) Applicant: Chia-Yeh Hsu, Taipei City (TW)

(72) Inventor: Chia-Yeh Hsu, Taipei City (TW)

(21) Appl. No.: 17/691,136

(22) Filed: Mar. 10, 2022

Related U.S. Application Data
(63) Continuation-in-part of application No. 16/593,949, filed on Oct. 4, 2019.

(30) Foreign Application Priority Data
Apr. 9, 2019 (TW) 108112359

(51) Int. Cl. G06Q 20/40; G06Q 20/34; G06Q 40/02; G06Q 20/38

(52) U.S. Cl. CPC G06Q 20/4016; G06Q 20/389; G06Q 40/02; G06Q 20/34

(57) ABSTRACT

A debt repayment system and a debt management method are provided. In the method, a transaction via a purchase carrier is received, and a purchase amount is obtained. A repayment plan including first and second stages is determined according to a total debt and the purchase amount and transmitted as a smart contract to a blockchain network. A first repayment in the repayment plan of the first stage relates to interest repayment without principal for the total debt, and a second repayment in the repayment plan of the second stage relates to interest repayment with principal for the total debt. A repayment transferred from a repay account is determined according to a debt ratio of credit bank. A risk coefficient corresponding to the current transaction is determined, and a candidate verification is selected according to the risk coefficient. The current transaction is accepted in response to passing the candidate verification.

### CROSS REFERENCE TO RELATED APPLICATION

This application is a continuation-in-part application of and claims the priority benefit of U.S. application Ser. No. 16/593,949, filed on Oct. 4, 2019, now pending, which claims the priority benefit of Taiwan application serial no. 108112359, filed on Apr. 9, 2019. The entirety of each of the above-mentioned patent applications is hereby incorporated by reference herein and made a part of specification.

### BACKGROUND OF THE DISCLOSURE

### Field of the Disclosure

The disclosure relates to a financial management technique, and in particular, to a type of debt repayment system and a debt management method.

### Description of Related Art

The number of people who owe card debt in our nation is about 800 thousands to 1 million. The debt-reduction regulations have called for a debtor of debt repayment and clearing to the court in the ten years of implementation. In particular, only 17,532 repayment programs were passed, with a ratio of 40.25%; more than 2,000 people were cleared and exempted, with a ratio of only 27.27%.

According to current trust regulations, the trustee may separately manage the trust property and the owner's property and the trust properties of other clients. If money is used as trust property, it may be handled separately by means of billing.

In terms of dealing with the personal debt of someone with card debt, if each debtor may handle the monetary debt via money trust, they will be more professional and more efficient at the same time. Taking debt repayment as an example, paying off debt by means of money trust is equivalent to requesting expert financial management, saving time and worry. By having an expert determine the risk of investment and using them as a tool for financial analysis, investment profitability is more efficient. Due to limited knowledge, time, and energy of individuals, it is impossible to conduct in-depth and extensive research and analysis on each financial product and investment target. However, via money trust, emotional, blind, and speculative personal investment may be avoided to achieve objective and professional investment judgment and profitability.

Moreover, if the bank processes the card debt, it will send a payment notice after the first month the cardholder owes the card debt. Then, legal action is taken via the court (including: requesting payment order or filing a lawsuit requesting for repayment of the loan). When the bank receives the green light for execution, it may execute compulsory pay deduction on the property of the debtor via the court.

Even if the bank executes compulsory pay deduction, it does not mean that the bank may fully take away all the cardholder's pay. The court considers the debtor's need to maintain his or her life, and in practice, the bank's compulsory deduction is allowed to be one-third.

It is also worth noting that the card debts of the person owing card debts belong to different credit banks. These groups face the vigorous recovery of many credit banks, which leads to physical and mental exhaustion and overwhelmedness. Therefore, in practice, the vast majority of people with card debts adopt an ostrich mentality and choose workplaces that provide cash (non-payroll) to escape the card debt recovery of the credit banks. As a result, the immense creditor's rights of the card-issuing banks are superficial, and after the loss of time, they have to recognize the loss of bad debts.

On the other hand, more and more banks attach importance to the security of transactions. Therefore, how to enhance the security of transactions becomes an important topic.

### SUMMARY OF THE DISCLOSURE

In view of this, the disclosure provides a debt repayment system and a debt management method that may provide a staged debt repayment plan, distribute repayments of several credit banks to effectively integrate the credit business of several banks, and provide risk evaluation for the transaction.

The debt repayment system of an embodiment of the disclosure includes multiple credit bank servers, a carrier-providing server, at least one sale terminal, an account management server, and a repayment distribution server. These credit bank servers respectively provide the total debt of the client. The carrier-providing server provides a purchase carrier and records the purchase situation of the purchase carrier, and the purchase carrier includes a physical card or a virtual card for pay. The sale terminal receives a transaction conducted via the purchase carrier and provides the purchase amounts of the transactions to the carrier-providing server. The account management server provides a repay account, and the repay account is used for saving the rebate of the purchase amount and repayment. The repayment distribution server determines a repayment plan including the first stage and the second stage according to the total debt and the purchase amount of the transaction and determines the repayment transferred from the repay account according to the debt ratio of the total debt corresponding to each credit bank server. The carrier-providing server provides the rebate of the purchase amount of the at least one transaction to the repayment distribution server, the repayment distribution server determines a first repayment for the first stage according to an interest of an interest repayment without a principal for the total debt and the rebate, the repayment distribution server determines a second repayment for the second stage according to the interest of the interest repayment with the principal for the total debt and the rebate, a duration of the first stage is different from a duration of the second stage, and the repayment distribution server transmits the repayment plan as a smart contract to a blockchain network. In response to one sale terminal receiving a current transaction of the at least one transaction conducted via the purchase carrier, the repayment distribution server obtains the smart contract recording the repayment plan via the blockchain network and determines a current stage of the repayment plan corresponding to the purchase carrier. In response to the current stage being the second stage, the repayment distribution server determines a risk coefficient corresponding to the current transaction and selects a candidate verification from a plurality of verification modes according to the risk coefficient. In response to a client terminal passing the candidate verification, the repayment distribution server accepts the current transaction.

Moreover, the debt management method of an embodiment of the disclosure includes the following steps. A transaction conducted via a purchase carrier is received and a purchase amount of the transaction is obtained. The purchase carrier includes a physical or virtual card for pay. Repayment plans for the first and second stages are determined according to a total debt and the purchase amount. The duration of the first stage is different from the duration of the second stage. A repayment transferred from a repay account is determined according to a debt ratio of each credit bank. The repay account is used for saving the first or second repayment and a rebate of the purchase amount. The first repayment for the first stage is determined according to an interest of an interest repayment without the principal for the total debt and the rebate. The second repayment for the second stage is determined according to the interest of the interest repayment with the principal for the total debt and the rebate. In response to receiving a current transaction of the at least one transaction conducted via the purchase carrier, the smart contract recording the repayment plan is obtained via the blockchain network and a current stage of the repayment plan corresponding to the purchase carrier is determined. In response to the current stage being the second stage, a risk coefficient corresponding to the current transaction is determined, and a candidate verification from a plurality of verification modes according to the risk coefficient is determined. In response to a client terminal passing the candidate verification, the current transaction is accepted.

Based on the above, the debt repayment system and the debt management method of an embodiment of the disclosure provide a two-stage repayment plan, and the client only needs to deposit the interest of the debt in each clearing cycle which is combined with the rebate corresponding to the current purchase amount via the purchase carrier of the client and deposited into the repay account together. The funds in the repay account are available for credit bank investments. In addition, in the second stage, the funds in the repay account may also be reclaimed according to the debt ratio of each credit bank, and the client may also take away the excess rebate. In this way, not only may the credit business of several credit banks be integrated, but the debtor may be able to pay off the debt and enable the credit bank to successfully recover the debt owed by the debtor. Furthermore, a proper verification would be provided on the transaction in the second stage with high risk, so as to improve the security of the transaction.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic of a debt repayment system according to an embodiment of the disclosure.

FIG. 2 is a block diagram of elements of a repayment distribution server according to an embodiment of the disclosure.

FIG. 3 is a flowchart of a debt management method according to an embodiment of the disclosure.

FIG. 4 is a flowchart of a verification of a transaction according to an embodiment of the disclosure.

### DESCRIPTION OF THE EMBODIMENTS

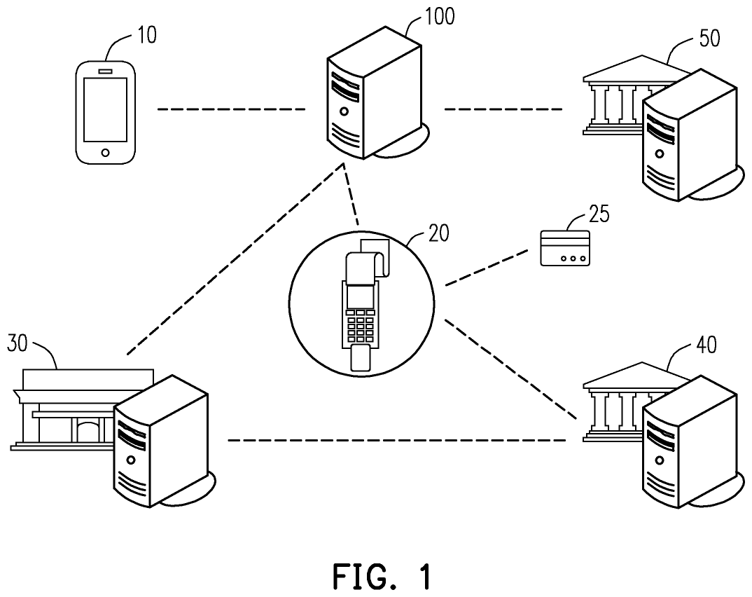

FIG. 1 is a schematic of a debt repayment system 1 according to an embodiment of the disclosure. The debt repayment system 1 includes at least but not limited to a client terminal 10, one or more sale terminals 20, a plurality of credit bank servers 30 providing loans, a carrier-providing server 40 providing a purchase carrier 25, an account management server 50 managing an account, and a repayment distribution server 100.

The client terminal 10 may be an electronic device such as a smart phone, a tablet computer, a notebook computer, a desktop computer, etc., and the client terminal 10 includes at least a network module (for example, supporting fourth generation or later generation mobile communication, Wi-Fi, or Ethernet, etc.), a display (e.g., an LCD or LED display, etc.), and a processor (e.g., a CPU, microcontroller, or application-specific integrated circuit (ASIC), etc.) to connect to the internet, display a user interface, or notify and perform computing functions. In the present embodiment, the client is the client terminal 10 and the client has a debt relationship with a credit bank, such as card debt, mortgage, etc.

The sale terminal 20 may be a physical terminal of a physical store (e.g., a card reader, a credit card machine, or a scanner (for one-dimensional or two-dimensional barcodes)), or a checkout platform/virtual terminal of an online store (e.g., a credit card network, e-wallet, third-party payment transaction platform, etc.), and may be connected to a carrier-providing server 40 providing the purchase carrier 25 to provide a transaction information (for example, the purchase carrier 25 used and the purchase amount, etc.) In addition, the purchase carrier 25 may be a virtual wallet related to electronic money (for example, a third-party payment, a financial institution such as an online bank (for example, provided by a bank or an insurance company)), and may be a physical payment product such as a credit card, a debit card, a stored value card, or a membership card, and may be a physical card or a virtual card (for example, a mobile payment).

The credit bank servers 30, the carrier-providing server 40, and the account management server 50 may be electronic devices such as various types of servers, workstations, and back hosts, and the credit bank servers 30, the carrier-providing server 40, and the account management server 50 at least include a network module (for example, supporting fourth generation mobile communication, Wi-Fi, or Ethernet, etc.), storage (for example, traditional hard disk drive (HDD), solid-state drive (SSD), etc.), and processor (for example, CPU, microcontroller, or ASIC, etc.) to connect to the internet, record the debt information (for example, interest, contract period, principal, total interest repayment with principal, repay account, and trust account, etc.) or transaction information (for example, the purchase carrier 25 used and purchase amount thereof, etc.) of the client (i.e., debtor) and perform computing functions. In the present embodiment, the credit bank servers 30 providing a loan represent servers set up by a financial institution providing a client loan (e.g., loan, card debt, credit purchase, bond, etc.) The carrier-providing server 40 represents a server set up by a financial institution issuing (providing) or managing the purchase carrier 25. The account management server 50 represents a server provided by a financial institution providing a repay account (which may transfer money to a credit bank). This repay account may be a trust account or other predesignated accounts.

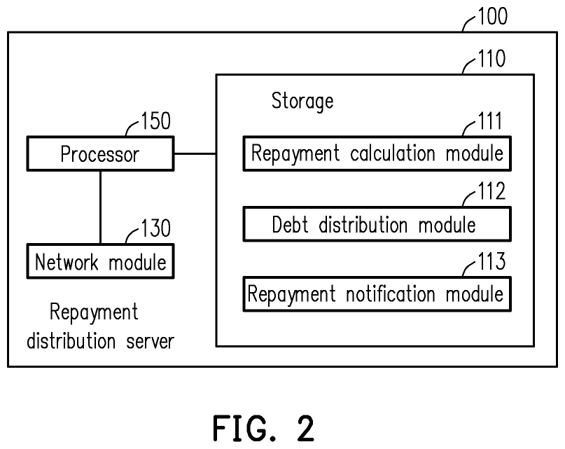

The repayment distribution server 100 may be an electronic device such as a computer host, a server, or a back host. FIG. 2 is a block diagram of elements of the repayment distribution server 100 according to an embodiment of the disclosure. Referring to FIG. 2, the repayment distribution server 100 includes at least but not limited to a storage 110, a network module 130, and a processor 150.

The storage 110 may be any type of fixed or removable random-access memory (RAM), read-only memory (ROM), flash memory, traditional hard disk drive (HDD), solid-state drive (SSD), or similar elements or a combination of the above. In the present embodiment, the storage 110 is used to store data or files such as buffered or permanent data, software modules (e.g., a repayment calculation module 111, a debt distribution module 112, and a repayment notification module 113, etc.), applications, debt information, transaction information, debt ratio, and repayment, and the details thereof are detailed in the subsequent embodiments.

The network module 130 may support communication transceivers such as fourth generation (4G) or later generation mobile communications, Wi-Fi, Ethernet, and fiber optic networks to connect to the internet.

The processor 150 is coupled to the storage 110 and the network module 130, and may be a central processing unit (CPU), or other programmable general-purpose or special-purpose microprocessor, digital signal processor (DSP), programmable controller, application-specific integrated circuit (ASIC), or other similar elements or a combination of the above. In an embodiment of the disclosure, the processor 150 is used to perform all of the operations of the repayment distribution server 100 and may load and perform each software module, file, and data recorded by the storage 110.

In order to facilitate the understanding of the operational flow of an embodiment of the disclosure, the following is a plurality of embodiments detailing the process of managing debt via the debt repayment system 1 in an embodiment of the disclosure. Hereinafter, the method described in an embodiment of the disclosure is described with respect to each device of the debt repayment system 1 and various elements and modules of the repayment distribution server 100. Each of the processes of the present method may be adjusted according to embodiment conditions and is not limited thereto.

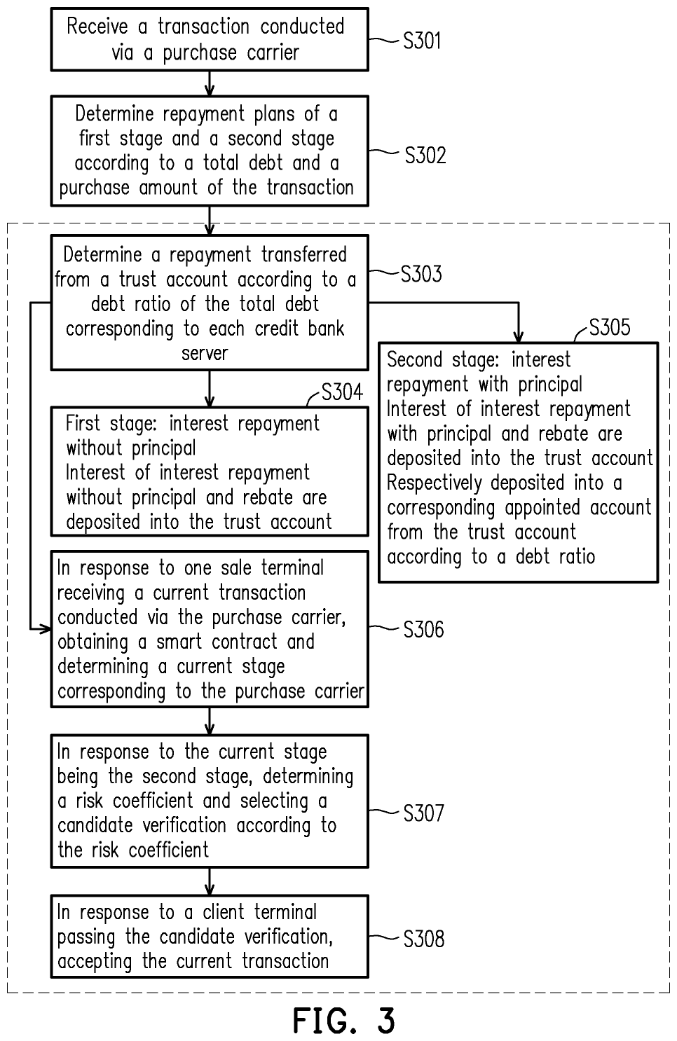

FIG. 3 is a flowchart of a debt management method according to an embodiment of the disclosure. Referring to FIG. 3, the debtor has a debt relationship with each credit bank (corresponding to the credit bank server 30), such as card debt or various types of loans. The debtor may agree with each credit bank to set up a repay account (for example, a trust account or other accounts) and a predesignated account (for example, a trust account or other accounts). The debtor may deposit the money into this repay account for debt repayment. The account management server 50 may set the repay account to have a fixed or set date to transfer a specific amount to the predesignated account of the credit bank. These credit bank servers 30 may provide the repayment distribution server 100 with a total debt for a particular client (i.e., debtor). This total debt is, for example, the sum of the card debt and the delayed interest, the total loan amount, etc., and may be adjusted according to the demand.

Moreover, the carrier-providing server 40 issues/provides the purchase carrier 25 for use by the debtor. Each of the sale terminals 20 may receive a transaction by the debtor via the purchase carrier 25 (step S301). In response to each transaction, the sale terminal 20 provides the purchase amount of the transaction to the carrier-providing server 40. The carrier-providing server 40 may then record the purchase situation based on the purchase carrier 25 (or historical purchase record). In particular, the purchase situation is related to the purchase amount on the physical or virtual sale terminal 20 via the purchase carrier 25, such as the purchase amount in one month, the purchase time and amount of a specific channel, and so on. It is worth noting that the carrier-providing server 40 further provides the purchase carrier 25 to obtain a rebate after purchase, such as a specific percentage of feedback, feedback points/tokens, and so on of the purchase amount. The carrier-providing server 40 may transfer the rebate of the purchase amount of the transaction to the repayment distribution server 100 or the repay account. The use of rebate is detailed in the following examples.

The repayment calculation module 111 of the repayment distribution server 100 may determine the repayment plan of the first stage and the second stage according to the total debt of the debtor and the purchase amount of the transaction within a certain billing cycle (for example, one month, one season, or half a year, etc.) (step S302). Specifically, in the face of large amounts of debt, the best tolerance for the debtor is to provide a discount for installments or staged repayments, giving the debtor the ability to pay off all debt. Therefore, how to set up a repayment plan to ease the burden on both the debtor and the creditor is a worthy issue for credit banks. In an embodiment of the disclosure, before the debt principal of the debtor is paid, a fixed interest (according to each debt ratio) needs to be paid to each credit bank (money trust) account (hereinafter referred to as a trust account). During the trust period, each credit bank may use these funds for (deposit/lending) to earn spreads or other types of investment profit for each credit bank trust account fund. It is worth noting that paying off debts by means of money trusts is to entrust expert financial management and to determine investment risks and analyze financial instruments by the expert, resulting in more efficient investment profit.

Moreover, an embodiment of the disclosure provides a two-stage purchase period. The difference in the repayment plan for this two-stage purchase period is that the content of the total debt repayment corresponding to the interest is different. That is, the duration of the first stage is different from the duration of the second stage. The first repayment in the repayment plan of the first stage (i.e., the amount the debtor should pay) is related to interest repayment of the total debt without principal. The repayment calculation module 111 determines the first repayment according to the interest of the interest repayment of the total debt without principal and rebate. Specifically, in the first stage, the debtor only needs to apportion the interest derived from the total debt (according to the specific interest rate) and does not have to pay the principal of the total debt. The first stage is referred to as a specific time segment, such as three, five, or twenty years. Here, the apportioned payment means the interest is evenly divided or distributed to each clearing cycle (for example, one month, or one season, etc.) according to a specific ratio, and the debtor only needs to deposit the distributed interest in the repay account every certain clearing cycle. For example, in the case of an annual interest rate of 2%, the debtor owes 1.2 million dollars in card debt, the deferred interest is also 1.2 million dollars, and the total debt is 2.4 million dollars. In the first stage (for example, the first year to the 20th year), according to a fixed 2% annual interest rate, about 4,000 dollars (2.4 million×2%/12) of interest (only interest repayment) is repaid per month in a 20-year total of 240 periods (assuming the clearing cycle is one month). That is, the total interest for 20 years is 960,000 dollars. In addition, the repayment notification module 113 may notify the carrier-providing server 40 via the network module 130 that the (all or part of) the rebate generated by purchase via the purchase carrier 25 is deposited into the repay account. When each clearing cycle of the first stage is expired, the repay account should be credited with the rebate and the apportioned interest within this clearing cycle. For example, if the purchase carrier 25 consumes 10,000 dollars in the current month and generates a rebate of 1,000 dollars, the repay account should be credited in the current month with 1,000 dollars (rebate) and 4,000 dollars (apportioned interest). The repayment notification module 113 may notify the client terminal 10 of the first or second repayment according to the stage (the first stage corresponds to the first repayment and the second stage corresponds to the second repayment) via the network module 130. The account management server 50 may have a predesignated debit mechanism with the debtor's account, and may automatically transfer a predetermined repayment from the debtor's account to the repay account upon expiration of each clearing cycle. If the debtor consumes 10,000 dollars a month, 240 months later, a total of 1.2 million dollars should be deposited into the repay account.

In addition, the second repayment in the repayment plan of the second stage (i.e., the amount the debtor should pay) is related to the interest repayment of the total debt with the principal. The repayment calculation module 111 determines the second repayment according to the interest of the interest repayment of the total debt with principal and the rebate. Specifically, in the second stage, the debtor needs to apportion the interest (according to the specific interest rate) derived from the total debt and the principal. The second stage refers to a specific time segment following the first stage, such as three, five, or twenty years. Here, the apportioned payment means the principal plus interest is divided evenly or distributed to each clearing cycle (for example, one month, or one season, etc.) according to a specific ratio, and the debtor only needs to deposit the distributed principal and interest in the repay account every specific clearing cycle. For example, in the case of an annual interest rate of 2%, the debtor owes 1.2 million dollars in card debt, the deferred interest is also 1.2 million dollars, and the total debt is 2.4 million dollars. In the case of a 20-year total of 240 periods, the total interest is 513,839 dollars, and the sum of principal and interest is 2,913,839 dollars (2.4 million plus 513,839). In the second stage (for example, the 21st to the 40 th year), the monthly contribution (assuming the clearing cycle is one month) is about 2,140 dollars (513,839/240) for principal and interest repayment. That is, the total interest for 20 years is 513,600 dollars (roughly close to 513,839 dollars). It should be noted that, in other embodiments, the original interest total may also directly carry the second highest number unit (for example, 10,000 in 513,839) (for example, 513,839 carried over by 10,000 is 520,000), and the total interest after the carry is evenly divided as interest that should be paid by the debtor for each clearing cycle. For example, 520,000 divided into 240 periods is about 2,166 dollars per month. Alternatively, the interest that should be paid for each clearing cycle may be adjusted according to the interest of the total debt. In addition, the repayment notification module 113 may notify the carrier-providing server 40 via the network module 130 that the (all or part of) the rebate generated by purchase via the purchase carrier 25 is deposited into the repay account. When each clearing cycle of the second stage is expired, the repay account should be credited with the rebate and the apportioned interest within this clearing cycle. For example, if the purchase carrier 25 consumes 10,000 dollars in the current month and generates a rebate of 1,000 dollars, the repay account should be credited in the current month with 1,000 dollars (rebate) and 2,140 dollars (apportioned interest). If the debtor consumes 10,000 dollars a month, 240 months later, a total of 753,600 dollars should be deposited into the repay account.

Next, the debt distribution module 112 may determine the repayment transferred from the repay account according to the debt ratio of the total debt corresponding to each of the credit bank servers 30 (step S303). Specifically, in order to integrate a number of credit banks for the debt of a particular client, the repayment distribution server 100 of an embodiment of the disclosure provides an automated debt distribution service. Each credit bank has a different amount of debt for a certain client. The debt distribution module 112 may add up the amount of debt of all of the credit banks for the client and calculate the ratio of each of the credit banks in the sum (total debt of client). For example, credit bank A has a client debt of 1 million, credit bank B has 500,000, and credit bank C has 500,000, and the debt ratio thereof is 2:1:1 (or 1/2, 1/4, and 1/4). Upon reaching each clearing cycle of each stage, the repay account should have a specific repayment deposited. The debt distribution module 112 confirms whether the repayment is the same as the first repayment or the second repayment (according to the stage). If different, the repayment notification module 113 notifies the client terminal 10 of the amount that is missing via the network module 130. If the same, the debt distribution module 112 notifies the account management server 50 via the communication module 130 to respectively transfer a specific amount from the repay account to each credit bank according to the debt ratio. For example, with a repayment of 5,000 dollars and a debt ratio of 2:1:1, 2,500 dollars is transferred to the predesignated account of credit bank A, 1,250 dollars is transferred to the predesignated account of credit bank B, and 1,250 dollars is transferred to the predesignated account of credit bank C. Each credit bank may use the transferred fund to make deposit/loan spread profit or other types of investments.

It should be noted that, in the first stage (that is, interest repayment without principal), the interest of the interest repayment without principal and the rebate via the purchase carrier 25 are deposited into the trust account of each credit bank from the repay account (step S304). It is worth noting that in the second stage (i.e., interest repayment with principal), in addition to the interest of the interest repayment with principal and the rebate via the purchase carrier 25 being deposited into the trust account of each credit bank from the repay account, the repayment deposited in the first stage and the second stage is respectively deposited into the corresponding predesignated account of the credit bank from the trust account according to the debt ratio (step S305). The repayment calculation module 111 calculates the reclaim amount of those credit bank servers 30 in the second stage. This reclaim amount may be a split or a specific proportion distribution of all income within the repay account. For example, the first stage should have a total of 1.2 million dollars deposited into the repay account, and the repayment calculation module 111 may transfer 10,000 dollars (that is, the reclaim amount) to the predesignated account of the credit bank every month within half of the second stage (for example, ten years) for the credit bank to reclaim. In response to the arrival of the second stage, the repayment notification module 113 may notify the credit bank servers 30 via the network module 130 to reclaim the debt owed by the debtor according to the debt ratio and the reclaim amount. For example, 10,000 dollars may be respectively transferred in 2,000 and 8,000 dollars to the predesignated accounts of the corresponding credit banks according to the debt ratio 1:4.

For example, the sum of the two stages should be a total fund of 1.95 million and 3,600 dollars (the total of 1.2 million and 753,600 in the previous example) that is deposited into the repay account. Regardless of whether each credit bank is used for (deposit/lending) to make a profit spread or other types of investment profit, or only for calculating meager interest at (annual interest rate 1%), the final repayment (sum of repayment and investment profit) thereof is far more than 2.4 million dollars, and is enough for the debt distribution module 112 to make monthly deposits (predesignated account) according to the debt ratio in the second stage for the carrier holder (debtor/bank) to reclaim month by month (can be used as the total debt of 2.4 million dollars for the monthly repayment of the credit bank).

In addition, in response to the arrival of the second stage, the repayment notification module 113 may also notify the client terminal 10 via the network module 130 to reclaim the purchase amount of the first stage. The credit bank makes an investment profit by depositing funds into the trust account, and the final total repayment thereof may exceed the original total debt. These excess amounts may be returned to the debtor to encourage their purchase behavior. The repayment calculation module 111 may determine the purchase amount returned to the debtor according to the difference between the total profit and the total debt returned by each of the credit bank servers 30. For example, this difference is apportioned and reclaimed monthly. In other words, the debtor may share the profit from the investment of the repayment by the credit bank.

It should be noted that, in order to promote purchase, the interest rate for the total debt may be further adjusted. In an embodiment, the repayment calculation module 111 may adjust the interest of the total debt according to the purchase amount of the purchase carrier 25 transaction. If the purchase amount is not less than the amount threshold value (for example, 10,000, 30,000, or 50,000, etc.), the repayment calculation module 111 lowers the interest rate of the total debt. As rebate is increased with the purchase amount, the final total repayment is also increased, such that the total repayment is more likely to exceed the total debt. For example, the credit bank may lower the annual interest rate by 0.5%, 0.8%, and 1% to lower the repayment that the debtor should pay in each clearing cycle. Moreover, if the purchase amount is less than the amount threshold value, the repayment calculation module 111 increases the interest rate of the total debt, so that the difference between the total repayment and the total debt is even smaller.

In some embodiments, all purchase amounts via the purchase carrier 25 in the first stage may also be respectively deposited into the corresponding predesignated account of the credit bank from the trust account according to the debt ratio. For example, if the debtor consumes 10,000 dollars per month, then after 20 years, all purchase amounts (or total purchase) is 2.4 million dollars. These purchase amounts may be reclaimed by the debtor on a monthly basis in the second stage, which may be used as the total debt of 2.4 million dollars for the monthly repayment of the credit bank. In other words, the amount that the debtor consumes via the purchase carrier 25 needs to be returned to the financial institution issued by the purchase carrier 25 in each clearing cycle of the second stage. The carrier-providing server 40 corresponding to the financial institution deposits these amounts into the repay account to be transferred to the predesignated account of each credit bank in the second stage.

It should be noted that, the foregoing examples all calculate interest at a fixed interest rate. In other embodiments, floating rate may also be applied, and the credit bank provides a solution for debit and credit.

Furthermore, the processor 150 transmits the repayment plan as a smart contract to a blockchain network through the network module 130. A smart contract is a computer program or a transaction protocol, and the smart contract may be intended to automatically execute, control, or document legally relevant events and actions according to the terms of a contract or an agreement. It should be noticed that the smart contract may have the objectives, for example, the reduction of need in trusted intermediates, arbitrations and enforcement costs, fraud losses, as well as the reduction of malicious and accidental exceptions. The processor 150 encapsulates the repayment plan in a block that is added to the blockchain network, and a smart contract recording the repayment plan is established. Some algorithms may secure the smart contract from attempts to tamper with it. For example, the repayment plan may be decrypted by a secret key such as a blockchain address.

Referring to FIG. 3, in response to one one of the one or more sale terminals 20 receiving a current transaction of the one or more transactions conducted via the purchase carrier 25, the processor 150 obtains the smart contract recording the repayment plan via the blockchain network through the network module 130, and the processor 150 determines a current stage of the repayment plan corresponding to the purchase carrier 25 (step S306). For example, the repayment distribution server 100 may retrieve the smart contract via a blockchain address with an identifier corresponding to the purchase carrier 25. Nodes on the network may verify that the identifier can solve a predefined hash function. The processor 150 compares the time of the current transaction with two stages recorded in the smart contract and determines the current stage is one of the first stage and the second stage at where the time of the current transaction is located.

It should be noticed that there is a lower risk in the first stage because the first repayment relates to interest repayment without a principal for the total debt. However, there is a higher risk in the second stage because the second repayment is larger than the first repayment. In response to the current stage being the second stage, the processor 150 determines a risk coefficient corresponding to the current transaction and selects a candidate verification from multiple verification modes according to the risk coefficient (step S307).

In one embodiment, the processor 150 may predict, through a predicting model, the risk coefficient according to financial statement and the repayment state of the client. The predicting model is trained by a machine learning algorithm with purchasing history and approved loan record. The machine learning algorithm may be a convolutional neural network (CNN), a recurrent neural network (RNN), a multi-layer perceptron (MLP), a support vector machine (SVM), a decision tree, or other algorithms. The machine learning algorithm analyzes training samples to obtain a relationship therein, to predict unknown data through the relationship. The predicting model is namely a machine learning model constructed after learning, and thereby inference is performed on the to-be-evaluated data. The financial statement may be the income/outcome statement, own real estate, own stock, own fund, and/or loan. In some embodiments, the financial statement may be the purchasing history of the client. The repayment state may be the repayment history, the repayment amount, and/or the duration of the stage.

The processor 150 may use the approved loan record and purchasing history of the others who have loans to label the predicted target, so as to figure out impact factors. The approved loan record includes the actual loans which have been approved. The purchasing history includes clients' purchase records. The processor 150 may use the approved loan, loan situation, and purchasing history to learn the logic/relationship between the input samples and the predicted result. Then, the predicting model can be used for predicting the risk coefficient. For example, if the repayment of the client is not on time usually or the purchasing history has less amount, the risk coefficient may be higher; otherwise, the risk coefficient may be lower. When (or only when) the risk coefficient is high, the current transaction is high. When (or only when) the risk coefficient is low, the current transaction is low.

In one embodiment, the risk coefficient may be determined according to the time of the current transaction. For example, if the time of the current transaction almost reaches the end of the second stage, the risk coefficient may be lower.

On the other hand, in one embodiment, the verification mode may be the dynamic password, telephone voiceprint, security question, and trust device verifications. For example, the short message (SMS)/e-mail one-time password (OTP), physical dynamic password machine, or near field communication (NFC) sensing verification. The processor 150 may select one verification mode corresponding to the determined risk coefficient as the candidate verification.

In one embodiment, a risk value range is divided into multiple sub-ranges, each verification mode corresponds to one of the sub-ranges. All risk coefficients are located within the risk value range. The processor 150 may select one verification mode having a sub-range at where the risk coefficient is located as the candidate verification. For example, the risk coefficient is 0.6, and the sub-range of SMS OTP mode is 0.5˜0.7. Then, the SMS OTP mode would be selected as a candidate verification.

In response to a client terminal 10 passing the candidate verification, the processor 150 accepts the current transaction (step S308). Specifically, the candidate verification is performed on the client terminal 10. When (or only when) the candidate verification is passed on the client terminal 10, the repayment distribution server 100 considers the current transaction has less risk and the current transaction is accepted. However, when (or only when) the candidate verification is not passed on the client terminal 10, the repayment distribution server 100 considers the current transaction has a higher risk and the current transaction is rejected.

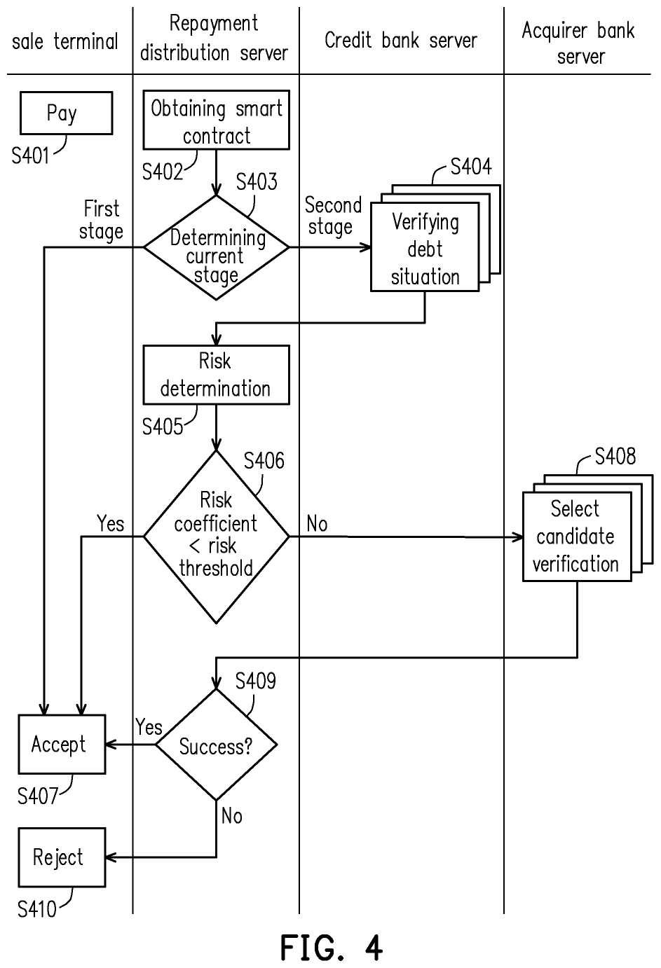

For example, FIG. 4 is a flowchart of a verification of a transaction according to an embodiment of the disclosure. Referring to FIG. 4, a QR code is scanned by a client terminal 10 for making a transaction (step S401). The mobile payment app is installed on the client terminal, and the virtual wallet of the app is the purchase carrier 25. The repayment distribution server 100 obtains the smart contract corresponding to the purchase carrier 25 (step S402). The repayment distribution server 100 determines which stage is the current stage according to the repayment plan extracted from the smart contract (step S403). If the current stage is the second stage with higher risk, the credit bank servers 30 may check the debt situation of the client (step S404) and transmit the approved loan record of the client to the repayment distribution server 100. The repayment distribution server 100 makes a risk determination to obtain a risk coefficient (step S405). For example, the risk determination factor includes the actual repayment situation, the remaining debt, and the monthly average purchase credit. In the case of A, the actual repayment situation is repayment on time every month and the remaining debt is less than 1 million dollars. The risk coefficient would be 0.2. However, in the case of B, the actual repayment situation is two records of delay and the remaining debt is larger than 4 million dollars. The risk coefficient would be 0.7.

The repayment distribution server 100 determines whether the risk coefficient is less than a risk threshold (step S406). For example, the risk coefficient is between 0 and 1, and the risk threshold is 0.1. If the current stage is the first stage or the risk coefficient is less than 0.1, the current transaction is accepted (step S407). That is, no further verification is needed. However, if the risk coefficient is not less than the risk threshold, the repayment distribution server 100 selects a candidate verification based on the risk coefficient (step S408). For example, table (1) is a mapping table between sub-ranges and the verification modes.

TABLE (1)

| Sub-ranges | Verification modes |
|---|---|
| 0.1~0.3 | e-mail OTP |
| 0.3~0.5 | SMS OTP |
| 0.5~0.7 | Telephone voiceprint |
| >0.7 | Security question via Telephone |

If the risk coefficient is 0.2, the candidate verification would be e-mail OTP mode. If the risk coefficient is 0.4, the candidate verification would be SMS OTP mode. If the risk coefficient is 0.6, the candidate verification would be the telephone voiceprint mode. If the risk coefficient is 0.8, the candidate verification would be the security question via Telephone mode. The mapping table may be established based on the security levels of the verification modes. For example, the security question mode may have a larger security strength than the e-mail OTP mode. Therefore, the values of the sub-range of the security question mode are larger than the values of the sub-range of the e-mail OTP mode.

The acquirer bank sever would issue the candidate verification with the client terminal 10 and transmit the verified result to the repayment distribution server 100. The repayment distribution server 100 determines whether the verified result is successful (step S409). If the candidate verification succeeded, the current transaction is accepted (step S407). If the candidate verification failed, the current transaction is rejected (step S410).

Based on the above, the debt repayment system and the debt management method of an embodiment of the disclosure provide a two-stage repayment plan for the debtor and the credit bank. In conjunction with the use of the purchase carrier, the rebate from the purchase of the debtor is used as repayment. In addition, in the two stages, the debtor only needs to apportion the interest corresponding to the interest repayment without principal and interest repayment with principal. In this way, the financial burden of the debtor may be greatly reduced. For the credit bank, these repayment funds may be used as investment, and there is an opportunity to fully recover the huge debt (profit with interest) of the recognized bad debt loss. An embodiment of the disclosure may also reorganize the credit business of several credit banks and allow the credit banks to conveniently manage the debts owed by each debtor. Moreover, an additional verification would be provided to enhance the security of the transaction.

Although the disclosure has been described with reference to the above embodiments, it will be apparent to one of ordinary skill in the art that modifications to the described embodiments may be made without departing from the spirit of the disclosure. Accordingly, the scope of the disclosure is defined by the attached claims not by the above detailed descriptions.

What is claimed is:

1. A debt repayment system, comprising:
a plurality of credit bank servers, respectively providing a total debt of a client;
a carrier-providing server, providing a purchase carrier and recording a purchase situation of the purchase carrier, wherein the purchase carrier comprises a physical card or a virtual card for a pay;
at least one sale terminal, receiving at least one transaction conducted via the purchase carrier and providing a purchase amount of the at least one transaction to the carrier-providing server;
an account management server, providing a repay account, wherein the repay account is used for saving a rebate of the purchase amount and a repayment; and
a repayment distribution server, determining a repayment plan comprising a first stage and a second stage according to the total debt and the purchase amount of the at least one transaction, and determining a repayment transferred from the repay account according to a debt ratio of the total debt corresponding to each of the credit bank servers, wherein
the carrier-providing server provides the rebate of the purchase amount of the at least one transaction to the repayment distribution server, the repayment distribution server determines a first repayment for the first stage according to an interest of an interest repayment without a principal for the total debt and the rebate, the repayment distribution server determines a second repayment for the second stage according to the interest of the interest repayment with the principal for the total debt and the rebate, a duration of the first stage is different from a duration of the second stage, the repayment distribution server transmits the repayment plan as a smart contract to a blockchain network,
in response to one of the at least one sale terminal receiving a current transaction of the at least one transaction conducted via the purchase carrier, the repayment distribution server obtains the smart contract recording the repayment plan via the blockchain network and determines a current stage of the repayment plan corresponding to the purchase carrier,
in response to the current stage being the second stage, the repayment distribution server determines a risk coefficient corresponding to the current transaction and selects a candidate verification from a plurality of verification modes according to the risk coefficient, and
in response to a client terminal passing the candidate verification, the repayment distribution server accepts the current transaction.

2. The debt repayment system of claim 1, wherein the repayment distribution server notifies the client terminal of the first or second repayment according to the stage, the repayment distribution server notifies the credit bank servers to reclaim a debt owed by a debtor according to the debt ratio and reclaim amount in the second stage, and the repayment distribution server notifies the client terminal to reclaim the purchase amount of the first stage in the second stage.

3. The debt repayment system of claim 1, wherein the repayment distribution server adjusts an interest rate of the total debt according to the purchase amount of the at least one transaction;
if the purchase amount is not less than an amount threshold value, the repayment distribution server lowers the interest rate of the total debt; and
if the purchase amount is less than the amount threshold value, the repayment distribution server increases the interest rate of the total debt.

4. The debt repayment system of claim 1, wherein a risk value range is divided into a plurality of sub-ranges, each of the plurality of verification modes corresponds to one of the plurality of the sub-ranges, and the repayment distribution server selects one of the plurality of verification modes having a sub-range at where the risk coefficient is located as the candidate verification.

5. The debt repayment system of claim 4, wherein the plurality of verification modes comprises dynamic password, telephone voiceprint, and trust device verifications.

6. The debt repayment system of claim 1, wherein the repayment distribution server predict, through a predicting model, the risk coefficient according to financial statement and the repayment state of the client, wherein the predicting model is trained by a machine learning algorithm with purchasing history and approved loan record.

7. A debt management method, implemented by a processor, and the method comprising:
receiving at least one transaction conducted via a purchase carrier and obtaining a purchase amount of the at least one transaction, wherein the purchase carrier comprises a physical card or a virtual card for a pay;
determining a repayment plan comprising a first stage and a second stage according to a total debt and the purchase amount of the at least one transaction and transmitting the repayment plans as a smart contract to a blockchain network, wherein a duration of the first stage is different from a duration of the second stage;
determining a repayment from a repay account according to a debt ratio of a plurality of credit banks for a total debt of a client corresponding to each of the credit banks, wherein the repay account is used for saving a rebate of the purchase amount and the first or second repayment, determining the repayment comprises:
determining the first repayment for the first stage according to an interest of an interest repayment without the principal for the total debt and the rebate; and
determining the second repayment for the second stage according to the interest of the interest repayment with the principal for the total debt and the rebate;
in response to receiving a current transaction of the at least one transaction conducted via the purchase carrier, obtaining the smart contract recording the repayment plan via the blockchain network, and determining a current stage of the repayment plan corresponding to the purchase carrier;
in response to the current stage being the second stage, determining a risk coefficient corresponding to the current transaction and selecting a candidate verification from a plurality of verification modes according to the risk coefficient; and
in response to a client terminal passing the candidate verification, accepting the current transaction.

8. The debt management method of claim 6, wherein determining the repayment transferred from the repay account further comprises:
notifying the client terminal of the first or second repayment according to the stage;
notifying credit bank servers to reclaim a debt owed by a debtor according to the debt ratio and reclaim amount in the second stage; and
notifying the client terminal to reclaim the purchase amount of the first stage in the second stage.

9. The debt management method of claim 7, further comprising, after determining the repayment transferred from the repay account:
adjusting an interest rate of the total debt according to the purchase amount of the at least one transaction;
lowering the interest rate of the total debt if the purchase amount is not less than an amount threshold value; and
increasing the interest rate of the total debt if the purchase amount is less than the amount threshold value.

10. The debt management method of claim 7, wherein a risk value range is divided into a plurality of sub-ranges, each of the plurality of verification modes corresponds to one of the plurality of the sub-ranges, and selecting the candidate verification from the plurality of verification modes according to the risk coefficient comprises:
selecting one of the plurality of verification modes having a sub-range at where the risk coefficient is located as the candidate verification.

11. The debt management method of claim 10, wherein the plurality of verification modes comprises dynamic password, telephone voiceprint, and trust device verifications.

12. The debt management method of claim 7, wherein determining the risk coefficient corresponding to the current transaction comprising:
predicting, through a predicting model, the risk coefficient according to financial statement and the repayment state of the client, wherein the predicting model is trained by a machine learning algorithm with purchasing history and approved loan record.
